(19) United States
(12) Patent Application Publication
(10) Pub. No.: US 2026/0205742 A1
(43) Pub. Date: Jul. 16, 2026

(54) METHOD FOR OPERATING A HEARING AID

(71) Applicant: Sivantos Pte. Ltd., Singapore (SG)

(72) Inventors: Tobias Daniel Rosenkranz, Erlangen (DE); Michael Bürger, Erlangen (DE); Sandro Kecanovic, Erlangen (DE)

(21) Appl. No.: 19/019,826

(22) Filed: Jan. 14, 2025

(51) Int. Cl. H04R 25/00

(52) U.S. Cl. CPC H04R 25/40; H04R 2225/41

(57) ABSTRACT

A method for operating a hearing device having a microphone and an output device for an output signal. An ambient sound is detected by the microphone, and a directional first audio signal is created based on the ambient sound, with a notch being directed in the direction of a desired sound source. A directional second audio signal is also created based on the ambient sound, with a notch directed into a spatial region that does not include the desired sound source. A factor is determined based on the relationship of an energy of the first audio signal to an energy of the second audio signal, and the output signal is created based on the ambient sound and the factor. The output signal is output by way of the output device.

### FIELD AND BACKGROUND OF THE INVENTION

The method relates to a method for operating a hearing aid and a hearing aid. Preferably, the hearing device is a hearing assistance device.

People who suffer from hearing loss usually use a hearing assistance device. In this case, an ambient sound is usually converted into an electrical (audio/sound) signal by way of a microphone, i.e., an electromechanical sound transducer, so that the electrical signal is detected. The recorded electrical signals are processed by way of an amplifier circuit and introduced into the person's ear canal by way of a further electromechanical transducer in the form of an earpiece. In most cases, the recorded signals are also processed, for which a signal processor of the amplifier circuit is usually used. In this case, the amplification is tailored to any hearing loss of the hearing aid wearer.

If the ambient sound also contains sound from a noise source, i.e. an unwanted source, this is also detected and amplified and introduced into the person's ear canal. This makes it difficult for the person to identify the desired components in the sound emitted into the ear canal. To avoid this, a microphone with two separate microphone units is usually used, by way of which an electrical signal is provided in each case. In this, the signals are superimposed and passed on to the receiver. By adjusting the time delay between the two electrical signals and applying gains, it is possible to change the directional characteristic of the microphone so that a main lobe and a notch are formed. The main lobe is directed towards the desired component, so that mainly the sound emitted by this component is processed and amplified by the amplifier circuit and delivered to the ear canal. The notch, on the other hand, is directed towards the source of the noise (noise source/direction of the noise), so that the sound emitted by this is not audible to the user, or only to a small extent. To prevent the desired component from being attenuated by the notch, the orientation (notch direction) is usually restricted to a specific area, such as behind the user.

If there is no noise source (source of interference), there is no unequivocal specification for the arrangement of the notch. This can lead to unwanted artifacts when the two signals are superimposed. As a result, the desired component may be attenuated and the microphone selfnoise may be amplified.

### SUMMARY OF THE INVENTION

The object of the invention is to provide a particularly suitable method for operating a hearing aid and a particularly suitable hearing aid, in particular one that increases comfort and/or makes following a conversation easier.

With regard to the method, this task is solved by the features of the claims and with regard to the hearing aid by the features of claims according to the invention. Advantageous further developments and designs are the subject of the respective sub-claims.

The method is used to operate a hearing aid. For example, the hearing aid is a headphone or includes headphones. However, the hearing aid preferably is a hearing assistance device. The hearing assistance device is used to support a person suffering from hearing loss. In other words, the hearing assistance device is a medical device that is used, for example, to compensate for partial hearing loss. The hearing assistance device is, for example, a “receiver-in-the-canal” hearing aid (RIC), an in-ear hearing aid, an “in-the-canal” (ITC) hearing aid or a ‘complete-in-canal’ (CIC) hearing aid, a hearing aid eyeglass, a pocket hearing aid, a bone-conduction hearing aid or an implant. The hearing aid is preferably a behind-the-ear (BTE) hearing aid worn behind the pinna.

The hearing aid is designed and intended to be worn on the human body. In other words, the hearing aid preferably includes a holding device that allows it to be attached to the human body. If the hearing aid is a hearing assistance device, the hearing aid is designed and arranged to be placed, for example, behind the ear or inside an ear canal. In particular, the hearing aid is wireless and designed and arranged to be inserted at least partially into an ear canal. The hearing aid particularly preferably includes an energy store that provides an energy supply.

The hearing aid also includes a microphone that is used to detect sound. In particular, when in operation, the microphone detects ambient sound, or at least part of it. The microphone is in particular an electromechanical sound transducer. The microphone has, for example, only a single microphone unit or several microphone units that interact with each other. Each of the microphone units conveniently has a membrane that is set into vibration by sound waves, whereby the vibrations are converted into an electrical signal by way of a corresponding recording device, such as a magnet that is moved in a coil. It is thus possible to capture an audio signal based on the sound striking the microphone unit by way of the respective microphone unit. In another embodiment, one or all the microphone units are MEMS microphones and therefore comprise or are made of a capacitive sensor. The microphone units are in particular omnidirectional in design. The microphone is appropriately arranged at least partially within a housing of the hearing aid and is thus at least partially protected.

Furthermore, the hearing aid has an output device for outputting an output signal. In this case, the output signal is in particular an electrical signal. The output device is, for example, an implant or, more preferably, an electromechanical sound transducer, preferably a loudspeaker, which is also referred to as an earpiece. Depending on the design of the hearing aid, in the intended state the output device is at least partially arranged within an ear canal of a wearer of the hearing aid, that is, a person, or is at least acoustically connected to it.

In the method, an ambient sound is detected by way of the microphone. Preferably, an audio signal, which is in particular an electrical signal, is created for this purpose by way of the microphone on the basis of the ambient sound. The ambient sound is caused by an external sound that includes, in particular, at least some components that can be traced back to a desired sound source, for example a person with whom the wearer/user of the hearing aid is talking. To determine this, the ambient sound, in particular, when it has been detected by way of the microphone, is suitably analyzed and, in particular, the components or some of them that can be traced back to the desired sound source are determined. For this purpose, for example, a frequency analysis is carried out, expediently of the possible audio signal.

On the basis of the ambient sound, in particular on the basis of the (detected) audio signal, a directional first audio signal is created. The first audio signal thus has a main lobe and at least one notch. The notch corresponds to a destructive interference and is directed in a certain direction. Sound originating from this direction is not contained in the first audio signal, or only to a small extent. In particular, the first audio signal corresponds to sound that is not caused by the desired sound source. For example, the main lobe of the first audio signal is fixed and/or directed in the opposite direction to the notch.

A directional second audio signal is also created based on the ambient sound. In other words, the second audio signal also has a main lobe and a notch. In this case, the notch of the second audio signal is directed into a spatial region that does not include the desired sound source. This ensures that the sound produced by the desired sound source is included in the second audio signal.

A factor is determined on the basis of the relationship of an energy of the first audio signal to an energy of the second audio signal. For this purpose, the two energies are divided by each other, for example, or the difference between the two energies is determined, depending in particular on how the respective energy is created. So, the ratio is used for the relationship. At least the relationship corresponds to a comparison of the energy of the first audio signal with the energy of the second audio signal. Particularly the difference is used for the relationship. For example, the energy is determined in each case in a frequency-selective manner, or, appropriately, this is merely a single value that is associated in particular with a specific frequency or with the frequency with the maximum amplitude.

The output signal, which is directional, for example, is created on the basis of the ambient sound and the factor,. If the relationship between the energy of the first and second audio signal changes, the factor changes and with it the output signal, for example. In this case, the output signal is directional for certain factors and omnidirectional for others. The output signal is then output using the output device. For example, post-processing is carried out before output, in particular depending on any hearing loss of the user of the hearing aid, who is also referred to as the wearer of the hearing aid.

The relationship can be used to deduce whether part of the ambient sound is caused by a source of interference (noise source). If essentially only the desired sound source conditions the ambient sound, the relationship between the two energies is comparatively large. In this case, it is more expedient to specify on the basis of the factor that, in particular, a directionality of the output signal is comparatively low, and the output signal is, for example, omnidirectional. In this case, it is not necessary to fade/filter out certain sound and to place a notch in a certain direction. This prevents the formation of artifacts. These would be comparatively noticeable to a user due to the otherwise comparatively quiet environment. However, if the two energies are essentially the same, the source of the interference is present. If the output signal had no directionality, the source of the interference would be essentially present in the output signal on an equal footing with the desired sound source. The factor is therefore used to determine the directionality so that the noise source is essentially faded out or at least attenuated. For example, a notch of the output signal is directed towards the noise source (interference source). In summary, there are therefore no artifacts in the output signal if there is no interference source, and if there is an interference source, it is attenuated/faded out. This always makes it easier for a user of the hearing aid to follow a conversation and increases comfort.

The assignment of the relationship to the factor is, for example, linear or preferably non-linear. In particular, the factor is specified using a formula or a table/map. It is useful for the table to be specified for the respective hearing aid, for example by a manufacturer of the hearing aid.

For example, the spatial region is fixed and determined in particular by the housing and therefore the orientation of the hearing aid. In this case, the area behind the respective user corresponds to the spatial region. However, the spatial region is preferably specified on the basis of the direction in which the desired sound source lies, so that the spatial region is dynamically adapted to the desired sound source. In particular, the boundaries of the spatial region in the direction of the desired sound source include an angle of 45°. Consequently, it is not possible to place the notch of the second audio signal in a cone with an opening angle of 90°. This reliably prevents the desired sound source from being unintentionally faded out.

It is expedient to adapt the notch of the second audio signal adaptively. In other words, an adaptive beamformer is used to create the second audio signal. This makes it possible to respond dynamically to the actual position of the possible noise source, which leads to a comparatively high ratio or predetermined relationship. It is also possible to use the same algorithm that is used to determine the output signal if it is directional. In this case, only the boundary conditions are different, for example. In the case of adaptive adjustment, the only requirement is that the notch is directed into the spatial region.

In one alternative, the notch of the second audio signal is fixed, for example. The notch is predetermined, for example, on the basis of the orientation of the possible housing of the hearing aid and is directed directly backwards. Alternatively, the notch is oriented in the opposite direction to the desired sound source. This ensures that the sound corresponding to the desired sound source is present in the second audio signal. Also, the calculation effort is reduced due to the specification of the notch.

For example, the notch of the second audio signal is specified directly. Several further directional audio signals are preferably created on the basis of the ambient sound. Thus, each further audio signal has a respective notch. This notch is directed into the spatial region and is specified in each case. Preferably, the notches are directed in different directions. For example, one of the notches is tilted by 90°, 180° and/or 270° with respect to the housing and/or the direction of the desired sound source. Alternatively, or in combination with this, an angle of 135° is formed in at least one and the respective direction. For example, the possible microphone unit are on a line pointing towards the front of the eventual housing. Then, a notch at 90° (left side) always also implies a notch to the 270° (right side). The second audio signal is then taken from the other audio signals with the lowest energy. Thus, the notch of the second audio signal is predetermined, but there is no rigid assignment. Therefore, it is possible that the orientation of the notch of the second audio signal differs for different situations. Due to the several further audio signals, the effort for determining the second audio signal is comparatively low, whereby the possible source of interference is nevertheless also taken into account comparatively accurately in the case of different positions. In a further embodiment, the notches of the further directional audio signals are adaptively adjusted in each case. However, each notch can only be adjusted in a respective spatial region, and the regions of the further directional audio signals are disjunctive.

For example, the factor is used to control the microphone appropriately, so that, for example, only one or certain microphone units are selected, provided that several are present, and the output signal is then created using these. For this purpose, the microphone is designed in particular as an array. Preferably, the sum of the second audio signal weighted by the factor and a first auxiliary signal weighted by a further factor is used as the output signal. The further factor is in particular equal to the difference between 1 and the factor, with the factor being suitably between 1 and 0, so that the further factor is also between 1 and 0. The direction of the notch of the second audio signal, for example, is directly fixed or is suitably adapted. In particular, the first auxiliary signal has a comparatively low noise level. The first auxiliary signal is also designed in such a way that the sound of the desired sound source is present in the first auxiliary signal with comparatively little interference. It is advantageous to use an omnidirectional (audio) signal as the first auxiliary signal, for example, without any post-processing. This reduces the effort required on the one hand. On the other hand, there are few artifacts in the first auxiliary signal. Since the second audio signal is already present, the effort is also comparatively low. In addition, if the notch is adapted adaptively, this results in a comparatively effective suppression of the sound from the possible source of interference. Conveniently, the first auxiliary signal is the omnidirectional signal. If the interference source is not present, the factor is used to specify that only the first auxiliary signal be used, which is why essentially no artifacts are then present in the output signal. If, on the other hand, the interference source is present, the factor is increased so that the second audio signal is strongly present in the output signal, which is why the interference source is effectively suppressed.

Alternatively, a directional second auxiliary signal is created based on the ambient sound. This second auxiliary signal also has a notch and a main lobe. The main lobe of the second auxiliary signal is directed towards the desired sound source. Thus, the desired sound source is represented with the help of the second auxiliary signal. The output signal is the sum of the second auxiliary signal and the first audio signal weighted by the factor, in which the notch is directed in the direction of the desired sound source. Thus, the second auxiliary signal and the first audio signal are essentially created in opposition to each other, and the factor is used to specify the directionality of the output signal with comparative accuracy. Also, the first audio signal has already been calculated to create the factor, which is why effort is reduced.

In an alternative, an adjusted factor is used instead of the factor, so that the output signal corresponds to the sum of the second auxiliary signal and the first audio signal weighted by the adjusted factor. The adjusted factor conveniently comprises and/or corresponds to the sum of the setting weighted by the factor. The setting weighted by the factor corresponds to the setting used to create the second audio signal, and the setting weighted by the further factor corresponds to the setting used for the first auxiliary signal. Therefore, the effort is reduced, even if the output signal is essentially always the same. In other words, the calculation effort is reduced, with the result being essentially the same.

To sum up, the output signal can be y=wx_{adaptive}+(1−w)x_{fixed}, where w is a weighing factor, x_{adaptive} is the adaptive beamformer output, and x_{fixed} is the fixed beamformer output. It is also possible to compute a convex combination of other quantities rather than the signal themselves, provided that those quantities represent somehow the respective directionality. One example is given by the adaptive differential microphone. The general output signal can be y=x_{card}+axₐₙₜᵢ, where a effectively describes the directivity of the beamformer and is preferably the factor described above. xₐₙₜᵢ is the signal of the beamformer with notch in direction of the desired source (e.g. 0°). x_{card} is the signal of the beamformer with notch to the back. In principle, other combinations are also possible as long as the two signals are linearly independent, which means in particular that the notch direction is different. Instead of computing a mixture of output signals, one can compute a mixture aₘᵢₓ of a_{adaptive} resulting from an adaptive algorithm and a_{fixed} describing a pre-defined fixed beampattern. So aₘᵢₓ=wa_{adaptive}+(1−w)a_{fixed}, and the output signal is then given by y=x_{card}+aₘᵢₓxₐₙₜᵢ.

The hearing aid comprises a microphone, an output device for an output signal and, for example, a signal processing unit. In particular, a signal path is formed by way of these, and the microphone preferably serves to pick up sound and the output device is suitable for providing sound. For example, the hearing aid is a headphone or includes a headphone. In this case, the hearing aid is designed as a so-called headset, for example. However, the hearing aid is particularly preferably a hearing assistance device. The hearing assistance device is used to support a person suffering from a hearing impairment. In other words, the hearing assistance device is a medical device that can be used, for example, to compensate for partial hearing loss. The hearing assistance device is, for example, a “receiver-in-the-canal” hearing aid (RIC), an “in-the-ear” hearing aid, an in-the-canal (ITC) or complete-in-canal (CIC) hearing aid, hearing glasses, a pocket hearing aid, a bone conduction hearing aid or an implant. The hearing aid can be a behind-the-ear (BTE) hearing aid worn behind the ear.

The hearing aid is operated according to a method in which an ambient sound is detected by way of the microphone. Based on the ambient sound, a directional first audio signal is created, with a notch directed in the direction of a desired sound source. Based on the ambient sound, a directional second audio signal is created, with a notch directed into a spatial region that does not include the desired sound source. A factor is determined based on the relationship of an energy of the first audio signal to an energy of the second audio signal. Based on the ambient sound and the factor, the directional output signal is created and the output signal is output by way of the output device. For example, the creation of the first/second audio signal and/or the factor and/or the output signal is carried out by way of the signal processing unit. In other words, the signal processing unit is suitable, in particular designed and set up to carry out the method at least partially or completely.

The hearing aid advantageously comprises a signal processor which advantageously forms the signal processing unit or at least is a component part thereof. The signal processor is for example a digital signal processor (DSP) or is realized by way of analog components. The signal processor is used in particular to adjust the output signal, preferably depending on any hearing loss of a wearer of the hearing aid. It is advantageous if an A/D converter is arranged between the microphone and the signal processing unit, for example the signal processor, if the signal processor is designed as a digital signal processor. The signal processor is set in particular depending on a parameter set. The parameter set is used to specify a gain in different frequency ranges, so that the output signal is processed according to certain specifications, in particular depending on the hearing loss of the wearer of the hearing aid. In particular, the hearing aid additionally comprises an amplifier, or the amplifier is at least partially formed by way of the signal processor. For example, the amplifier is connected upstream or downstream of the signal processor in terms of the signal.

The further developments and advantages described in connection with the method are also to be applied mutatis mutandis to the hearing aid and vice versa.

Other features which are considered as characteristic for the invention are set forth in the appended claims.

Although the invention is illustrated and described herein as embodied in a method for operating a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 schematically shows a hearing aid,

FIG. 2 shows a method for operating the hearing aid,

FIG. 3 shows a directional characteristic of a first audio signal,

FIGS. 4, 5 each show a possible directional characteristic of a second audio signal, and

FIG. 6 shows a directional characteristic of a first auxiliary signal.

Parts corresponding to one another are provided with the same reference signs in all figures.

### DETAILED DESCRIPTION OF THE INVENTION

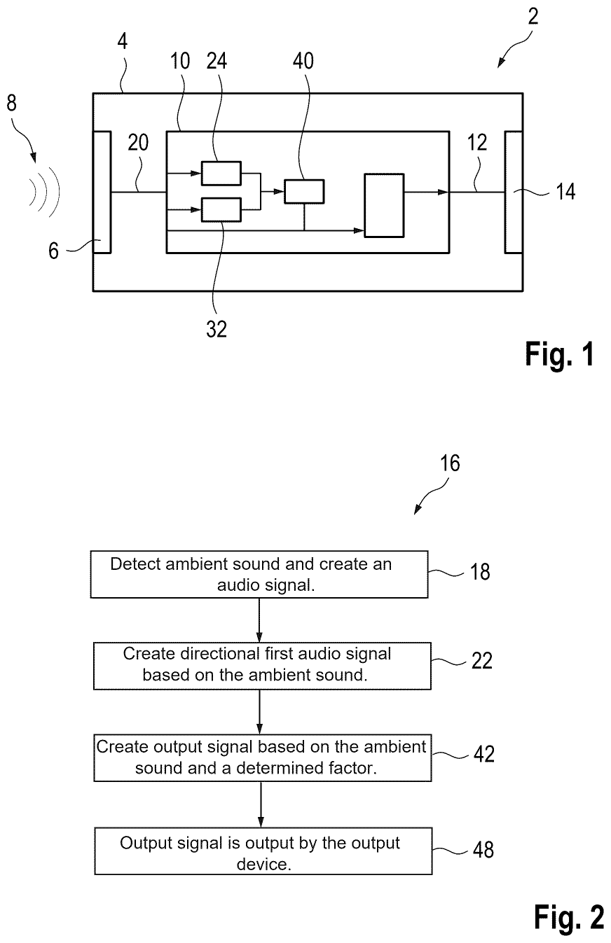

FIG. 1 schematically shows a simplified hearing aid 2 in the form of a hearing assistance device. The hearing aid 2 has a housing 4 by way of which a microphone 6 is received. The microphone 6 has several microphone units that are not shown in more detail, by way of which an omnidirectional (audio) signal can be created based on ambient sound 8. In terms of the signal, the microphone 6 is followed by a signal processing unit 10, by way of which an output signal 12 is provided. Furthermore, an output device 14 is arranged in the housing 4, which is designed as a receiver and is followed by the signal processing unit 10 in terms of the signal. The output device 14 is used to output the output signal 12.

The hearing aid 2 is operated in accordance with a method 16 shown in FIG. 2, which is carried out at least partially by way of the signal processing unit 10. In a first step 18, the ambient sound 8 is detected by way of the microphone 6, for which an audio signal 20 is created by way of the microphone 6 and is passed from the microphone 6 to the signal processing unit 10. The audio signal 20 has a plurality of components, each of the components being provided by way of a respective one of the microphone units.

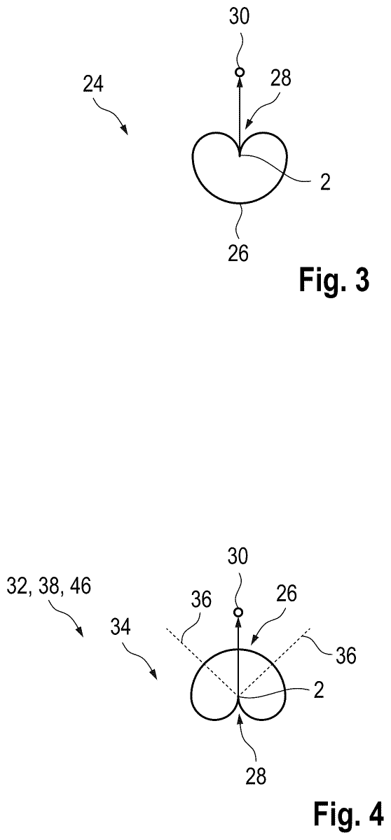

In a subsequent second step 22, a directional first audio signal 24 is created on the basis of the ambient sound 8, namely on the basis of the audio signal 20 based on the ambient sound 8, the directional characteristic of which is shown in FIG. 3 in a schematically simplified manner. The first audio signal 24 is directional and has a main lobe 26 and a notch 28. To provide this, at least some of the individual components of the audio signal 20 are added, using a suitable time offset between them. The notch 28 is directed towards a desired sound source 30. The presence and direction of the desired sound source 30 with respect to the hearing aid 2 is determined by way of another method, in particular by analyzing the audio signal 20.

Furthermore, in the second step 22, a second audio signal 32 is created whose directional characteristic is shown schematically in FIG. 4. The second audio signal 32 is also directional and thus exhibits the notch 28 and the main lobe 26. In this case, the notch 28 is not directed towards the desired sound source 30, but rather towards a spatial region 34. The spatial region 34 is created and defined in such a way that the desired sound source 30 is not located within it. In the illustrated example, the boundaries 36 of the spatial region 34 point in the direction of the desired sound source 30 at an angle of 45°. This precludes the notch 28 of the second audio signal 32 from lying in a cone that is concentric with the direction in which the desired sound source 30 lies and that has an opening angle of 90°.

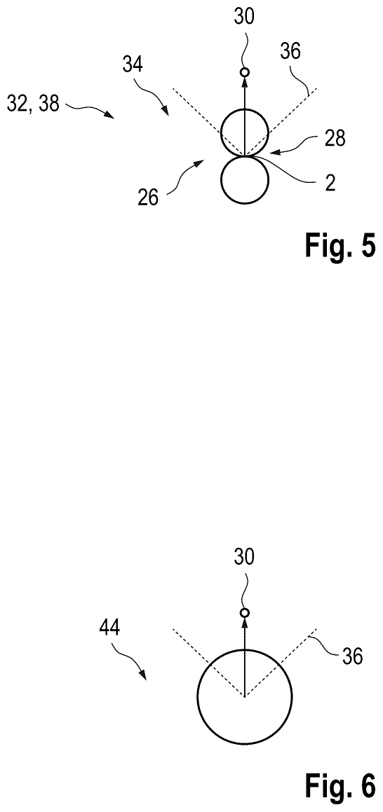

The notch 28 of the second audio signal 32 is adaptively adjusted, for example. In this case, the notch 28 is directed towards an interference/noise source, which is not represented in more detail, that is located in the spatial region 34. In another variant, the notch 28 of the second audio signal 32 is predetermined. In this case, the notch 28 is directed in the opposite direction with respect to the desired sound source 30, so that the directional characteristic of the second audio signal 32, as shown in FIG. 4, is also obtained. However, it is also possible for the notch 28 to have a different direction, as shown in FIG. 5, for example. In this case, the notch 28 forms an angle of 90° with the direction in which the desired sound source 30 is located. Also, there is also another notch at 270°.

In another variant, a plurality of further audio signals 38 are created, which are also directional and thus each have the notch 28. For the further audio signals 38, the notch 28 is predetermined in each case and differs between the individual further audio signals 38. These are each directed into the spatial region 34, which is why the variants shown in FIGS. 4 and 5 can be used as the directional characteristic of the further audio signals 38. In particular, the direction of a notch 28 to the direction in which the desired sound source 30 lies includes an angle of 90°, another includes an angle of 180° and another includes an angle of 270°. For each of the further audio signals 38, the respective level is created and the one with the lowest level is determined. This is then used as the second audio signal 32.

For the first audio signal 24 and the second audio signal 32, a respective level is created and the ratio between them is determined. In other words the relationship of the first audio signal 24 and the second audio signal 32 is determined. For this purpose, for example, the difference between the two levels is determined, or they are divided by each other. A factor 40 is determined on the basis of this ratio. The way in which the factor 40 is determined is adapted to the respective hearing aid 2 and is specified by a manufacturer of the hearing aid 2. To create the respective level, the energy of the respective signal in the logarithm domain is determined.

In a subsequent third step 42, the output signal 12 is created on the basis of the ambient sound 8 and the factor 40. Thus, the output signal 12 is based on the ambient sound 8. A weighted sum is used to create the output signal 12. In one variant, the sum of the second audio signal 32, which is weighted by the factor 40 and in which the notch 28 is adapted adaptively as appropriate, and the first auxiliary signal 44, which is weighted by a further factor and whose directional characteristic is shown in FIG. 6, is used as the output signal 12. The first auxiliary signal 44 is an omnidirectional signal, so that it has no preferred direction, and thus no main lobe or notch. In this variant, the factor 40 is between 0 and 1, and the further factor is the difference between 1 and the factor 40. Thus, this is also between 0 and 1.

The factor 40 is 0 if the difference between the first and second audio signals is 24, 32 high. In this case, the level of the first audio signal 24 is comparatively small and there are essentially no sources of interference. Thus, the omnidirectional first auxiliary signal 44 can be used as the output signal 12, whereby essentially no other sound sources are perceptible to a user of the hearing aid 2, with the exception of the desired sound source 30. If the levels of the first and second audio signals 24, 32 do not differ significantly, at least one or more sources of interference are present. In this case, the factor 40 is equal to 1, so that the second audio signal 32 is essentially used as the output signal 12. If the conditions are in between, adjusted factors 40 and further factors are used so that the second audio signal 32 and the first auxiliary signal 44 are superimposed.

In another variant, a directional second auxiliary signal 46 is created based on the ambient sound 8, namely based on the audio signal 20. In this case, the main lobe 26 is directed towards the desired signal source 30, so that the directional characteristic corresponds to the directional characteristic shown in FIG. 4. The second auxiliary signal 46 is also added to the first audio signal 24, which is weighted by the factor 40, and the sum is used as the output signal 12. In this variant, the functional relationship between the factor 40 and the ratio is adjusted accordingly, so that here too, when there is no source of interference, the output signal 12 has a minimal directional characteristic, whereas when there is a comparatively loud and/or multiple sources of interference, the output signal 12 has a directional characteristic and thus directionality.

After the output signal 12 has been created in each case, it is output in a fourth step 48 by way of the output device 14. In particular, a sound that is not represented in more detail is generated for this purpose, which is conveniently introduced into an ear canal of the user of the hearing aid 2.

The invention is not limited to the embodiments described above. Rather, other variants of the invention can be derived therefrom by a person skilled in the art without leaving the scope of the invention. In particular, all the individual features described in connection with the individual embodiments can also be combined with each other in other ways without leaving the scope of the invention.

The following is a summary list of reference numerals and the corresponding structure used in the above description of the invention:
2 Hearing aid
4 Housing
6 Microphone
8 Ambient sound
10 Signal processing unit
12 Output signal
14 Output device
16 Method
18 First step
20 Audio signal
22 Second step
24 First audio signal
26 Main lobe
28 Notch
30 Desired sound source
32 Second audio signal
34 Spatial region
36 Boundary
38 Further audio signals
40 Factor
42 Third step
44 First auxiliary signal
46 Second auxiliary signal

1. A method for operating a hearing device having a microphone and an output device for an output signal, the method comprising:
detecting an ambient sound via the microphone;
creating a directional first audio signal based on the ambient sound, and directing a notch in the direction of a desired sound source;
creating a directional second audio signal based on the ambient sound, and directing a notch into a spatial region which does not include the desired sound source;
determining a factor based on a relationship of an energy of the first audio signal to an energy of the second audio signal;
creating the output signal based on the ambient sound and the factor; and
outputting the output signal via the output device.

2. The method according to claim 1, wherein boundaries of the spatial region form an angle of 45° with the direction of the desired sound source.

3. The method according to claim 1, wherein the notch of the second audio signal is adaptively adjusted.

4. The method according to claim 1, wherein the notch of the second audio signal is predetermined.

5. The method according to claim 4, wherein a plurality of further directional audio signals are created using the ambient sound, a respective notch being directed into the spatial region and predetermined, and the further audio signal having the lowest energy being used as the second audio signal.

6. The method according to claim 1, wherein the output signal is based on the sum of the second audio signal weighted by the factor and a first auxiliary signal weighted by a further factor, wherein the output signal is the difference between 1 and the factor.

7. The method according to claim 1, further comprising:
creating a directional second auxiliary signal based on the ambient sound;
directing a main lobe of the second auxiliary signal in the direction of the desired sound source; and
basing the output signal on the sum of the second auxiliary signal and the first audio signal weighted by the factor.

8. A hearing device comprising a microphone and an output device for an output signal, wherein the hearing device is configured to be operated according to the method of claim 1.
